(19) United States
(12) Patent Application Publication
(10) Pub. No.: US 2017/0213550 A1
(43) Pub. Date: Jul. 27, 2017

(54) ADAPTIVE DUAL COLLABORATIVE KALMAN FILTERING FOR VEHICULAR AUDIO ENHANCEMENT

(71) Applicants: Hyundai America Technical Center, Inc, Superior Township, MI (US); Hyundai Motor Company, Seoul (KR); Kia Motors Corporation, Seoul (KR)

(72) Inventor: Mahdi Ali, Detroit, MI (US)

(21) Appl. No.: 15/005,644

(22) Filed: Jan. 25, 2016

(51) Int. Cl. G10L 15/20; G10L 25/84; G10L 15/22; G10L 21/0232; G10L 21/0264

(52) U.S. Cl. CPC G10L 15/20; G10L 21/0232; G10L 21/0264; G10L 15/22; G10L 25/84; G10L 2015/228

(57) ABSTRACT

A method includes: acquiring speech signals in a vehicle; dividing the speech signals into speech segments including one or more speech samples; processing a set of the speech segments using dual Kalman filters; and synthesizing the processed speech segments to construct noise-reduced speech signals. Each dual Kalman filter includes a first Kalman filter and a second Kalman filter, each speech segment in the set is processed using a different dual Kalman filter, and each speech segment in the set is processed in parallel with one another.

### BACKGROUND

(a) Technical Field

The present disclosure relates generally to vehicular audio systems, and more particularly, to adaptive dual collaborative Kalman filtering for vehicular audio enhancement.

(b) Background Art

Voice recognition-enabled applications have become increasingly common in modern vehicles. Such technology allows for the driver of a vehicle to perform in-vehicle functions typically requiring the use of hands, such as making a telephone call or selecting music to play, by simply uttering a series of voice commands. This way, the driver's hands can remain on the steering wheel and the driver's gaze can remain directed on the road ahead, thereby reducing the risk of accidents. For instance, Most North American vehicles are equipped with Bluetooth capability, which is a short range wireless communication that operates in the Industrial Scientific and Medical (ISM) band at 2.4 to 2.485 GHz. Bluetooth allows drivers to pair their phones with the vehicles' audio system and establish hands free calls utilizing the vehicles' audio system.

Voice recognition, or speech recognition, applications recognize spoken language and translate the spoken language into text or some other form which allows a computer to act on recognized commands Various models and techniques for performing voice recognition exist, such as the Autoregressive (AR) model, hidden Markov models, dynamic time warping, and neural networks, among others. There are various advantages to each voice recognition model, including greater computational efficiency, increased accuracy, improved speed, and so forth.

Of course, common to all voice recognition approaches is the process of acquiring speech signals from a user. When voice recognition is attempted in a noisy environment, however, performance often suffers due to environmental noises muddying the speech signals from the user. Such problems arise when performing voice recognition in a vehicle, as several sources of noise exist inside of the vehicle (e.g., radio, HVAC fan, engine, turn signal indicator, window/sunroof adjustments, etc.) as well as outside of the vehicle (e.g., wind, rain, passing vehicles, road features such as pot holes, speed bumps, etc.). As a result, the cabin of the vehicle often contains a mixture of different noises, each with different characteristics (e.g., position, direction, pitch, volume, duration, etc.).

Additionally, vehicle cabin noises are also typically non-stationary in nature and vary rapidly with time. Therefore, the mixture of noises makes it difficult for one filter alone to reduce the noise in a vehicle cabin to a satisfactory level, particularly in real-time applications. The result is degraded audio quality in “hands-free” Bluetooth-based conversations and poor voice recognition accuracy.

Several techniques for enhancing speech signals through noise reduction have been proposed. However, many conventional approaches to noise reduction in vehicles are excessively complex. For instance, some approaches include filtering the frequency components of acquired speech signals by converting the signals from the time domain to the frequency domain and then back to the time domain, which adds computational complexity to the system. Other approaches rely on assumptions that filtering processes and noises are stationary. However, as explained above, vehicle noises are often non-stationary, causing poor audio quality especially in high noise environments (e.g., when driving at high speed on the highway). Yet other approaches require structural modifications to the vehicle, such as installing microphones at different locations throughout the vehicle.

Furthermore, use of the Kalman Filter (KF) for noise reduction has been explored. The KF is an efficient recursive filter that estimates the internal state of a linear dynamic system from corrupted measurements by minimizing the Minimum Mean Squared Error (MMSE). Use of Kalman Filtering is premised on the notion that if a number of past samples are known, the future samples can be predicted and updated based on the continuously collected measurements. In the case of noise reduction, the KF can accept noisy speech signals as input and attempt to predict a noise-less version of the inputted speech signals using recursively performed algorithms.

### SUMMARY OF THE DISCLOSURE

The present disclosure provides techniques for utilizing several linear adaptive dual Kalman filters (ADKFs) that collaborate to reduce the different types of noises that corrupt speech signals and cause poor hands-free audio quality in vehicles. Rather than transforming acquired speech signals from the time domain to the frequency domain and then back to the time domain, the present disclosure enables optimal use of the Kalman filter by keeping the speech signals in the time domain. Particularly, acquired speech signals are decomposed into smaller segments in the time domain, and each segment is processed by one ADKF, which can be tuned based on noise information gathered from the controller area network (CAN) bus of the vehicle. All segments are processed in parallel by different ADKFs, which contributes to a higher processing speed. Thus, the reduced complexity of computations and higher processing speed makes it possible to use the techniques disclosed herein in real-time applications. Further, the techniques are versatile in their application, as there is no need to assume that the speech signals or noises are stationary.

According to embodiments of the present disclosure, a method includes: acquiring speech signals in a vehicle; dividing the speech signals into speech segments including one or more speech samples; processing a set of the speech segments using dual Kalman filters; and synthesizing the processed speech segments to construct noise-reduced speech signals. Each dual Kalman filter includes a first Kalman filter and a second Kalman filter, each speech segment in the set is processed using a different dual Kalman filter, and each speech segment in the set is processed in parallel with one another.

The processing of the speech segments may include: determining n dual Kalman filters, each of the n dual Kalman filters being different from one another; and processing a first set of n speech segments in parallel with one another using the n dual Kalman filters. Each of the n speech segments in the first set may be processed, respectively, using a corresponding dual Kalman filter of the n dual Kalman filters. The processing of the speech segments may further include: processing a second set of n speech segments in parallel with one another using the n dual Kalman filters. Each of the n speech segments in the second set may be processed, respectively, using a corresponding dual Kalman filter of the n dual Kalman filters. The processing of the speech segments may also include: determining n dual Kalman filters, each of the n dual Kalman filters being different from one another; and processing a plurality of sets of n speech segments using the n dual Kalman filters. Each set of n speech segments may be processed in a sequential order, each of the n speech segments in any given set may be processed in parallel with one another, each of the n speech segments in any given set may be processed, respectively, using a corresponding dual Kalman filter of the n dual Kalman filters.

The dividing of the speech signals into speech segments may include: grouping one or more speech samples in each speech signal, resulting in the speech segments. The one or more speech samples may be grouped according to time. The speech signals may be divided into speech segments according to time.

The speech segments may contain a reduced amount of noise after the processing of each speech segment using the dual Kalman filters. The processed speech segments may be noise-reduced speech segments. Further, each speech segment may be processed using a different combination of a first Kalman filter and a second Kalman filter.

The processing of the speech segments may also include: estimating a speech sample based on a first speech segment among the set of speech segments based on one or more estimated coefficients using the first Kalman filter; and estimating the one or more coefficients based on the estimated speech sample using the second Kalman filter. The one or more estimated coefficients may be estimated according to an autoregressive (AR) model.

The method may further include: receiving vehicle information provided by a controller area network (CAN) bus of the vehicle; estimating noise parameters of the speech signals based on the received vehicle information; and tuning the dual Kalman filters according to the estimated noise parameters of the speech signals. The set of speech segments may be processed using the tuned dual Kalman filters. The vehicle information provided by the CAN bus may include one or more of: an engine speed, a fan level, a wind amount, a window position, and a radio volume level.

The synthesizing of the processed speech segments may include: reconstructing speech segments based on filtered speech samples resulting from the processing of the speech segments using the dual Kalman filters; and synthesizing the reconstructed speech segments to construct the noise-reduced speech signals.

Furthermore, according to embodiments of the present disclosure, an apparatus includes: an audio acquisition device acquiring speech signals in a vehicle; and a controller installed in the vehicle configured to: divide the speech signals acquired by the audio acquisition device into speech segments including one or more speech samples, process a set of the speech segments using dual Kalman filters, and synthesize the processed speech segments to construct noise-reduced speech signals. Each dual Kalman filter includes a first Kalman filter and a second Kalman filter, each speech segment in the set is processed using a different dual Kalman filter, and each speech segment in the set is processed in parallel with one another.

The controller may be further configured to: receive vehicle information provided by a controller area network (CAN) bus of the vehicle; estimate noise parameters of the speech signals based on the received vehicle information; and tune the dual Kalman filters according to the estimated noise parameters of the speech signals. The set of speech segments is processed using the tuned dual Kalman filters.

Furthermore, according to embodiments of the present disclosure, a non-transitory computer readable medium containing program instructions for performing a method in a vehicle includes: program instructions that divide speech signals acquired by an audio acquisition device in the vehicle into speech segments including one or more speech samples; program instructions that process a set of the speech segments using dual Kalman filters; and program instructions that synthesize the processed speech segments to construct noise-reduced speech signals. Each dual Kalman filter includes a first Kalman filter and a second Kalman filter, each speech segment in the set is processed using a different dual Kalman filter, and each speech segment in the set is processed in parallel with one another.

The non-transitory computer readable medium may further include: program instructions that receive vehicle information provided by a controller area network (CAN) bus of the vehicle; program instructions that estimate noise parameters of the speech signals based on the received vehicle information; and program instructions that tune the dual Kalman filters according to the estimated noise parameters of the speech signals. The set of speech segments may be processed using the tuned dual Kalman filters.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates a diagrammatic example of a conventional method for reducing noise in speech signals using a dual Kalman Filter;

FIG. 2 illustrates a diagrammatic example of a method for reducing noise in speech signals using multiple adaptive dual Kalman Filters according to embodiments of the present disclosure;

FIG. 3 illustrates a composition of an example speech signal;

FIG. 4 illustrates an example method of conventional AR model-based processing in series; and

FIG. 5 illustrates an example method of parallel processing using collaborative, adaptive dual Kalman Filtering according to embodiments of the present disclosure.

It should be understood that the above-referenced drawings are not necessarily to scale, presenting a somewhat simplified representation of various preferred features illustrative of the basic principles of the disclosure. The specific design features of the present disclosure, including, for example, specific dimensions, orientations, locations, and shapes, will be determined in part by the particular intended application and use environment.

### DETAILED DESCRIPTION OF THE EMBODIMENTS

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. The term “coupled” denotes a physical relationship between two components whereby the components are either directly connected to one another or indirectly connected via one or more intermediary components.

It is understood that the term “vehicle” or “vehicular” or other similar term as used herein is inclusive of motor vehicles, in general, such as passenger automobiles including sports utility vehicles (SUV), buses, trucks, various commercial vehicles, watercraft including a variety of boats and ships, aircraft, and the like, and includes hybrid vehicles, electric vehicles, hybrid electric vehicles, hydrogen-powered vehicles and other alternative fuel vehicles (e.g., fuels derived from resources other than petroleum). As referred to herein, an electric vehicle (EV) is a vehicle that includes, as part of its locomotion capabilities, electrical power derived from a chargeable energy storage device (e.g., one or more rechargeable electrochemical cells or other type of battery). An EV is not limited to an automobile and may include motorcycles, carts, scooters, and the like. Furthermore, a hybrid vehicle is a vehicle that has two or more sources of power, for example both gasoline-based power and electric-based power (e.g., a hybrid electric vehicle (HEV)).

Additionally, it is understood that one or more of the below voice recognition methods, or aspects thereof, may be executed by at least one controller or controller area network (CAN) bus. The controller or controller area network (CAN) bus may be implemented in a vehicle, such as the host vehicle described herein. For instance, the controller can be responsible for implementing the adaptive dual Kalman Filters, as described in detail herein. The term “controller” may refer to a hardware device that includes a memory and a processor. The memory is configured to store program instructions, and the processor is specifically programmed to execute the program instructions to perform one or more processes which are described further below. Moreover, it is understood that the below methods may be executed by an apparatus comprising the controller in conjunction with one or more additional components, as described in detail below.

Furthermore, the controller of the present disclosure may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

Referring now to embodiments of the present disclosure, the disclosed techniques utilize multiple dual Kalman Filters (i.e., two coupled Kalman Filters) that work jointly to reduce noise generated inside and/or outside of a vehicle which can corrupt speech signals acquired in the vehicle's cabin. Further, the dual Kalman Filters are adaptive in the Kalman Filters can be tuned in real-time based on vehicle noise information received from the controller area network (CAN) bus of the vehicle. As a result, there is no need to assume stationary processes when calculating Autoregressive (AR) parameters or noise characteristics. In addition, having a bank of Kalman Filters makes it possible to use multiple Kalman Filters, which contributes to increased processing speeds making it possible to use the Kalman Filtering techniques described herein in real-time applications. Further to this point, there is no need to convert signals from the time domain into the frequency domain and then re-convert the signals back to the time domain, unlike in conventional approaches.

Using the dual Kalman filtering approach described herein, at an initial processing step, speech segments are constructed of certain number of unfiltered speech samples (e.g., four, eight, etc.), and n number of segments are processed by n number of adaptive dual Kalman filters producing n number of filtered speech samples. In the subsequent processing step, a new set of n segments are processed by the n number of adaptive dual Kalman filters producing new n of filtered samples, and so on. In this way, in each time step, n filtered samples are produced. For example, if it is decided to use four adaptive dual Kalman filters (the number of Kalman filters used depends of the application), four filtered samples are produced at each time step, instead of one single filtered sample when applying the conventional AR method.

The dual Kalman Filters can operate according to various models, such as the Autoregressive (AR) model, one of the most common methods for modeling speech signals. The AR model can be performed by taking a relatively small segment of a speech signal and predicting the next speech signal using prior samples. To this end, S_{K|K-1} represents a speech signal at sample k that can be predicted recursively using past speech samples up to k−1. Using the AR model with the pth order, a speech signal can be modeled according to Equation 1.

$${S}_{k \vert k - 1} = {\sum }_{i = 1}^{p} {a}_{i} {S}_{k - i} + {w}_{k} \qquad [ Equation 1 ]$$

Here, αᵢ are prediction coefficients; wₖ is the so-called “driving process,” which is assumed to be a non-zero mean noise with variance σ_{w}²; and p is the order.

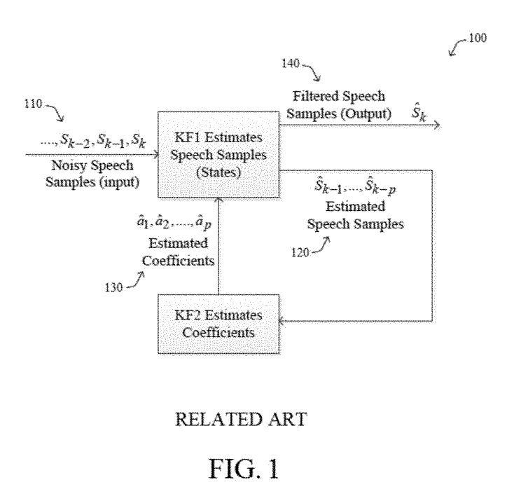

In further detail, FIG. 1 illustrates a diagrammatic example of a conventional method for reducing noise in speech signals using a dual Kalman Filter. As shown in FIG. 1, the dual Kalman Filtering procedure 100 includes a first Kalman Filter (KF1) using a new observation to estimate the incoming speech signal S_{K|K-1} based on the past measured received signals Sₖ₋₁, Sₖ₋₂, . . . , Sₖ₋ₚ, and includes a second Kalman Filter (KF2) using this estimated signal to estimate the AR coefficients αᵢ. That is, as shown in FIG. 1, KF1 estimates speech samples Ŝₖ₋₁, Ŝₖ₋₂, . . . , Ŝₖ₋ₚ (120) using noisy speech samples . . . Sₖ₋₂, Sₖ₋₁, Sₖ as input (110) and estimated coefficients â₁, â₂, . . . , âₚ from KF2 as input (130), while KF2 estimates the coefficients â₁, â₂, . . . âₚ (130) using the estimated speech samples Ŝₖ₋₁, Ŝₖ₋₂, . . . , Ŝₖ₋ₚ from KF1 as input (120). This is called joint estimation since both the signal Sₖ and the coefficients αᵢ need to be estimated, and the estimated values depend on each other. This allows the analysis to be run linearly and avoid using any nonlinear approximation methods. After multiple iterative cycles of the dual Kalman Filtering process, KF1 outputs a filtered speech sample Ŝₖ (140) which is an approximation of a noise-less version of the noisy speech samples which were previously received as input.

In detail, the procedure 100 for dual estimations using dual Kalman Filters described herein can operate as follows.

### Estimation of the Speech Samples (KF1)

Let Sₖ=[Sₖ Sₖ₋₁ . . . Sₖ₋ₚ₊₁]^{T}. In order to use Kalman Filtering, Equation 1 needs to be put in the following state space format, in accordance with Equations 2 and 3:

Sₖ=ΦₖSₖ₋₁+gwₖ [Equation 2]

yₖ=HSₖ+νₖ [Equation 3]

When p=4, these matrices are defined as follows:

$${Φ}_{k} = [ \begin{matrix}- {a}_{1} & - {a}_{2} & - {a}_{3} & - {a}_{4} \\ 1 & 0 & 0 & 0 \\ 0 & 1 & 0 & 0 \\ 0 & 0 & 1 & 0\end{matrix} ] , g = [ \begin{matrix}1 \\ 0 \\ 0 \\ 0\end{matrix} ] , \\ H = [ \begin{matrix}1 & 0 & 0 & 0\end{matrix} ] \qquad [ Equation 4 ]$$

Thus, the goal is to estimate the speech samples Ŝ_{k|l} at t=k given l noisy observations of y₁, y₂, . . . , yₗ and to calculate the output HSₖ as well. H is called the output matrix, and νₖ is the measurement noise with zero mean and covariance σ_{ν}², which is measured during the silent periods. The a posteriori Ŝ_{k|k} is defined as:

Ŝ_{k|k}=ΦₖŜ_{k-1|k-1}+Kₖrₖ [Equation 5]

Here, rₖ is the so-called innovation process and is defined as:

rₖ=yₖ−HΦₖŜ_{k-1|k-1} [Equation 6]

Its covariance can be defined as:

Cₖ=HP_{k|k-1}H^{T}+σ_{ν}² [Equation 7]

The so-called a priori error covariance matrix P_{k|k-1} can be calculated recursively as:

P_{k|k-1}=ΦₖP_{k-1|k-1}Φₖ^{T}+gσ_{w}²g^{T} [Equation 8]

Kₖ is known as the Kalman Gain and is calculated as follows:

Kₖ=P_{k|k-1}H^{T}Cₖ⁻¹ [Equation 9]

The so-called a posteriori covariance is updated as follows:

P_{k|k}=(Iₖ−KₖH)P_{k|k-1} [Equation 10]

Finally, the output of KF1 is the filtered speech samples and can be expressed as:

Ŝₖ=HŜ_{k|k}[Equation 11]

The estimated samples Ŝ_{k|k} are fed into KF2 as the observed values and used for the purposes of coefficients estimation (described below), and Ŝₖ will be processed throughout the rest of the model blocks. The state vector and its covariance can be initialized as Ŝ₀=0 and P₀=I.

### Estimation of the Coefficients (KF2)

The state vector Ŝₖ, which was estimated by KF1, is used as the observed value for KF2. In order to estimate the coefficients from the estimated phase, Equations 5 and 11 are combined as

Ŝₖ=HΦₖŜₖ₋₁+HKₖνk=Ŝₖ₋₁^{T}aₙ+νₖ [Equation 12]

For the 4^{th} order system, the speech samples and coefficients vectors are defined as: Ŝₖ₋₁=[Ŝₖ₋₁ Ŝₖ₋₂ Ŝₖ₋₃ Ŝₖ₋₄]^{T} and aₙ=[−a₁−a₂−a₃−a₄]^{T} respectively. In the event that the phase signal is stationary or changing very slowly from the current value to the next one, it is possible that the coefficients can be approximately time invariant over a short period of time. In this case, they can be written as:

aₙ=aₙ₋₁ [Equation 13]

The state space equations for KF2 can now be defined to estimate the coefficients as:

aₙ=aₙ₋₁ [Equation 13]

Ŝₖ=Ŝₖ₋₁^{T}aₙ+νₖ [Equation 14]

Here, the vector Ŝ^{T}ₖ₋₁ becomes the observed values, and the vector aₙ contains the states to be estimated. The covariance of the process νₖ can be calculated as:

σ_{νk}²=HKₖCₖKₖ^{T}H^{T} [Equation 15]

The coefficients can be recursively computed as:

â_{k|k}=â_{k-1|k-1}+Kₖ^{a}(Ŝₖ−Ŝₖ₋₁^{T}â_{k-1|k-1}) [Equation 16]

Here, the Kalman Gain K^{a}ₖ and the updated state covariance matrix P^{a}ₖ can be calculated as:

Kₖ^{a}=P_{k-1|k-1}^{a}Ŝₖ₋₁(Ŝₖ₋₁^{T}P_{k-1|k-1}^{a}Ŝₖ₋₁+σₖ²)⁻¹ [Equation 17]

P_{k|k}^{a}=(Iₖ−Kₖ^{a}Ŝₖ₋₁^{T})P_{k|k-1}^{a} [Equation 18]

In the same manner as above, the initial state and its covariance can be initialized as Ŝ₀=0 and P₀=I respectively.

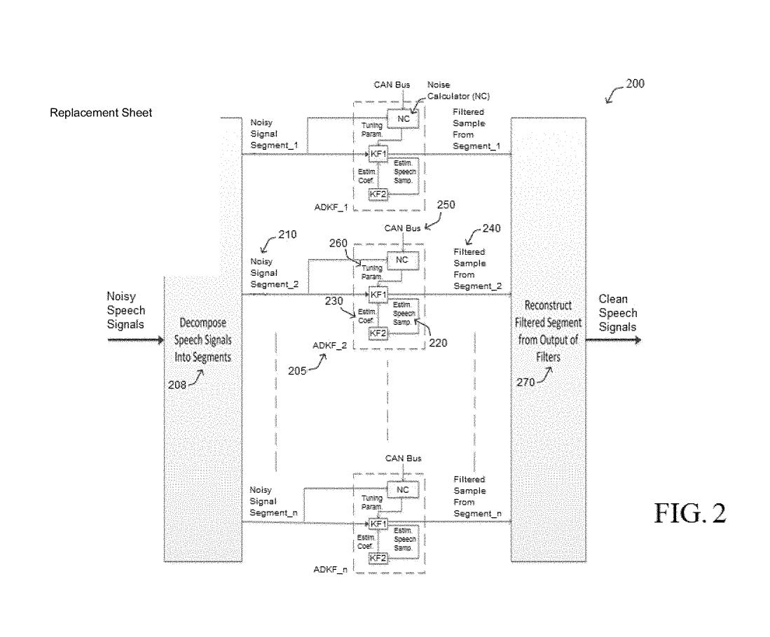

Meanwhile, the embodiments of the present disclosure involve noise cancellation techniques using multiple adaptive dual Kalman Filters (ADKFs) in collaboration with one another. In this regard, FIG. 2 illustrates a diagrammatic example of a method for reducing noise in speech signals using multiple dual Kalman Filters according to embodiments of the present disclosure. As shown in FIG. 2, the dual Kalman Filtering procedure 200 includes multiple ADKFs 205 (ADKF_1, ADKF_2, . . . , ADKF_n), in each of which a first Kalman Filter (KF1) estimates speech samples (220) using noisy speech signal segments (noisy signal segment_1, noisy signal segment_2, . . . , noisy signal segment_n) as input (210) and estimated coefficients from KF2 as input (230), and a second Kalman Filter (KF2) estimates the coefficients (230) using the estimated speech samples from KF1 as input (220).

Initially, speech signals from a user (e.g., a driver or passenger) may be acquired in a vehicle using an audio acquisition device (not shown), such as a microphone or the like, installed in the vehicle. Of course, the speech signals may be corrupted by noise generated by sources inside of the vehicle (e.g., radio, HVAC fan, engine, turn signal indicator, window/sunroof adjustments, etc.) as well as outside of the vehicle (e.g., wind, rain, passing vehicles, road features such as pot holes, speed bumps, etc.).

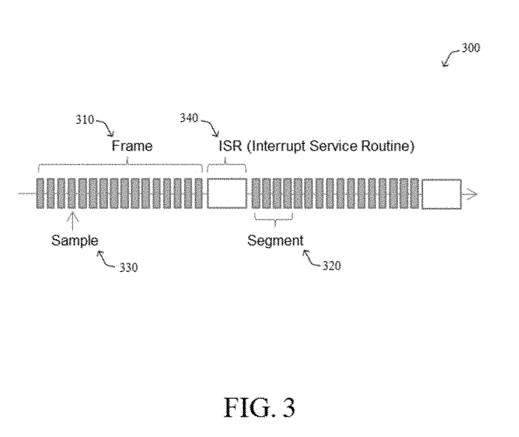

After acquisition, the noisy speech signals may be decomposed into several smaller speech segments (208). Each speech segment may include a number of speech samples, and the speech samples may be grouped together, thereby forming a speech segment. In this regard, FIG. 3 illustrates a composition of an example speech signal. As shown in FIG. 3, a speech signal 300 may be composed of frames 310 separated by interrupt service routines (ISRs) 340. Each frame 310 may have a number of samples 330, where the number of samples 330 varies according to the application. The samples 330 may be grouped together into segments 320. According to the present disclosure, the speech signals 300 can remain in the time domain, rather than converting them into the frequency domain and then back to the time domain. Thus, the speech samples 330 may be grouped together according to time to form the speech segments 320. For example, speech samples at time t₀ can be grouped together as a first speech segment, speech samples at time t₁ can be grouped together as a second speech segment, and so forth.

Referring back to FIG. 2, once the speech signals have been decomposed into segments (208), each segment can be processed by one of the multiple ADKFs 205 (ADKF_1, ADKF_2, . . . , ADKF_n). Specifically, the segments can be processed as one set of n segments at a time, as described in further detail below. Each of the ADKFs 205 includes a first Kalman Filter (KF1) and second Kalman Filter (KF2). Notably, each ADKF 205 is different from one another. That is, each ADKF 205 includes a uniquely configured first Kalman Filter and second Kalman Filter. Thus, every speech segment can be processed by a different ADKF 205. As a result, the need for higher order filters is eliminated, reducing overall complexity. Furthermore, the different segments of the speech signal (noisy signal segment_1, noisy signal segment_2, . . . , noisy signal segment_n) can be processed by the ADKFs 205 in parallel with one another. The processing speed of the speech signals is increased by handling multiple segments at one time. Also, the procedure 200 can handle non-stationary noise types, since each ADKF 205 works on a small segments (i.e., a small number of speech samples) versus the entire frame as in other methods. As a result, all of the ADKFs 205 work together by each filtering one segment of the speech signal, thereby collaborating with one another to efficiently remove noise from noisy speech signals.

As explained above, each ADKF 205 consists of a dual Kalman Filter, in which a first Kalman Filter (KF1) and a second Kalman Filter (KF2) reduce noise for a specific speech segment (noisy signal segment_1, noisy signal segment_2, . . . , noisy signal segment_n). In each ADKF 205, the KF1 accepts the noisy signal segment (210) as input and uses the estimated AR coefficients (230) from KF2 to estimate speech samples (220), and the KF2 uses the estimated speech samples (22) from KF1 to estimate the AR coefficients (230). This process can be performed recursively, as explained above with respect to FIG. 1, to produce a filtered (i.e., noise-less) sample (filtered sample from segment_1, filtered sample from segment_2, . . . , filtered sample from segment_n) based on the received noisy segment (240).

Because each ADKF 205 is unique, there can be n different ADKFs 205, as illustrated in FIG. 2. As such, the n different ADKFs 205 can process n speech segments in parallel at a time. However, the speech signals may have been decomposed (208) into more than n speech segments. In this case, the n different ADKFs 205 can process a plurality of sets of n speech segments in a sequential order (i.e., a first set of n segments is processed in parallel, followed by a second set of n segments processed in parallel, and so forth). For instance, as shown in FIG. 2, noisy signal segment_1 can be processed by ADKF_1, noisy signal segment_2 can be processed by ADKF_2, and so forth, with noisy signal segment_n being processed by ADKF_n.

In addition, the ADKFs 205 can be tuned based on vehicle information received from a controller area network (CAN) bus 250 in the vehicle before and/or during the filtering of a noisy speech segment. The vehicle information may include information regarding events which potentially cause noise in the vehicle cabin. In this manner, the ADKFs 205 can be adjusted in real-time based on events that often create noise corrupting a user's speech signals. The ADKFs 205 can process the acquired speech signals more effectively by having knowledge of currently occurring noise-producing events.

The vehicle information provided by the vehicle CAN bus 250 can include, for instance, one or more of an engine speed, a fan level, a wind amount, a weather indication, a window position, a sunroof position, a radio volume level, a turn indicator status, a presence of passing vehicles, a road feature (e.g., pot holes, speed bumps, etc.), and the like. The vehicle information may further include specific details about a noise producing event, for instance, a type and/or characterization of the noise producing event, a location of the noise producing event, a duration and/or consistency of the noise producing event, an intensity of the noise producing event, and so forth.

As shown in FIG. 2, a noise calculator can produce tuning parameters (260) based on the vehicle information provided by the CAN bus 250. The noise calculator can be implemented in a variety of ways, as would be understood by a person of ordinary skill in the art, including implemented as part of the ADKF 205, as shown in FIG. 2, or implemented by a controller of the vehicle. Thus, the specific configuration shown in FIG. 2 is not intended to limit the scope of the present disclosure. The tuning parameters can be generated in real-time and reflect the currently occurring noise producing event(s), as well as specific details about the noise producing event(s). The noise calculator can also receive the noisy signal segments as input and produce the tuning parameters in view of the received speech segments.

The tuning parameters can then be used to tune the ADKFs 205—making the dual Kalman Filters adaptive—to enable the ADKFs 205 more effectively handle noisy speech segments. In other words, the ADKFs 205 can process acquired speech segments more effectively knowing that the radio is currently on and playing music through speakers positioned throughout the vehicle, that the vehicle is currently driving at 70 mph on the highway, and that there are several other vehicles passing by the vehicle in the opposite direction, as an example. This allows the ADKFs 205 to identify and isolate noise corrupting the acquired speech signals more easily.

After the recursive process is performed by tuned ADKFs 205 (i.e., KF1 estimating speech samples (220) based on estimated AR coefficients, and KF2 estimating the AR coefficients (230) based on the estimated speech samples), a filtered (i.e., noise-less) sample (filtered sample from segment_1, filtered sample from segment_2, . . . , filtered sample from segment_n) is produced (240). Then, the filtered samples can be reconstructed (270) to finally produce clean speech signals. That is, after processing by the ADKFs 205, the noise-reduced speech segments may be synthesized to construct noise-reduced speech signals.

As explained above, AR models are commonly used in noise reduction applications for predicting clean speech signals. The AR model uses past sample observations to predict the properties of the current sample, as calculated according to Equation 19.

s(k)=Σᵢ₌₁^{p}αᵢs(n−i)+w(k) [Equation 19]

Equation 19 can be re-stated as follows, for an order of p=8, as an example:

s(k)=a₁s(k−1)+a₂s(k−2)+a₃s(k−3)++a₄s(k−4)+a₅s(k−5)+a₆s(k−6)+a₇s(k−7)+a₈s(k−8) [Equation 20]

Traditionally, AR models have been used in a serial sequence to filter one speech sample at a time, whereby filtered samples are used to forecast future samples. However, the traditional AR modeling procedure is too slow for real-time noise reduction applications.

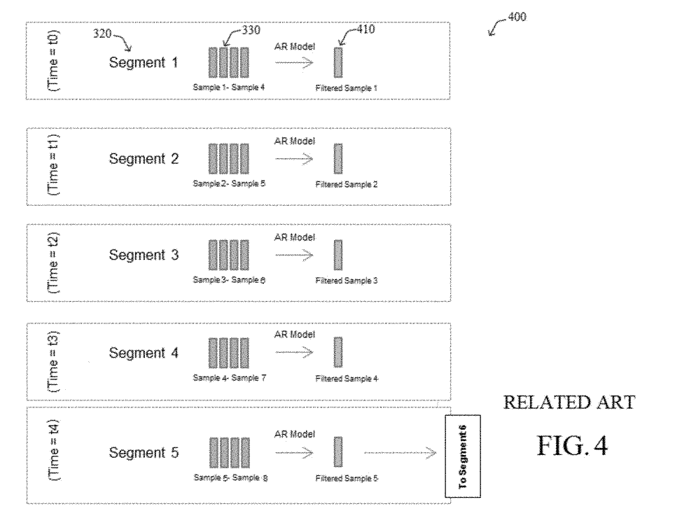

In this regard, FIG. 4 illustrates an example method of conventional AR model-based processing in series. As shown in FIG. 4, five filtered samples 410 are produced during five time iterations. At time t₀, a conventional AR model-based processing method 400 processes a noisy speech segment 1 containing unfiltered speech samples 1-4 using the AR model. The processing at time t₀ results in a filtered sample 1 which represents a noise-less estimation of one or more samples 330 of the noisy segment 1. Next, at time t₁, the conventional AR model-based processing method 400 processes a noisy speech segment 2 containing unfiltered speech samples 2-5 using the AR model. The processing at time t₁ results in a filtered sample 2 which represents a noise-less estimation of one or more samples 330 of the noisy segment 2. The conventional AR model-based processing method 400 can be repeated until all speech segments 320 have been processed, one at a time, by the AR model. Thus, if there are x speech segments 320 to be processed, x iterations of speech segment processing are performed to estimate x filtered samples 410.

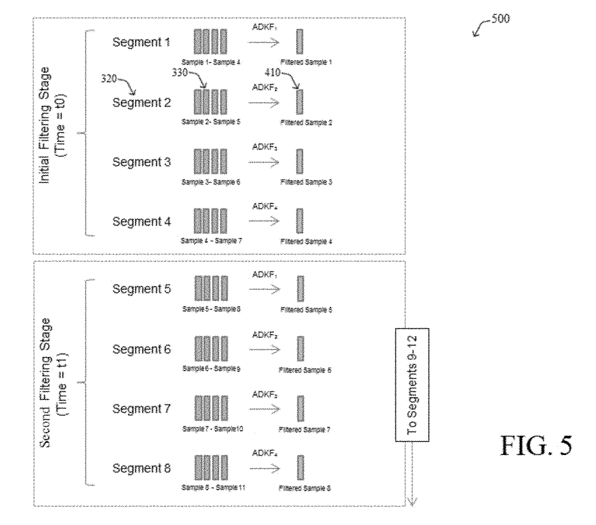

In contrast, FIG. 5 illustrates an example method of parallel processing using collaborative, adaptive dual Kalman Filtering according to embodiments of the present disclosure. As shown in FIG. 5, in each cycle, a collaborative, parallel processing method 500 processes a set of n speech segments (segment 1, segment 2, segment 3, segment 4) in parallel using n unique ADFKs (ADFK₁, ADFK₂, ADFK₃, ADFK₄), whereby segment 1 is processed using ADFK₁, segment 2 is processed using ADFK₂, and so forth, in the manner as described in detail above. Here, n=4, meaning that four speech segments can be processed in parallel using four ADFKs. That is, the initial iteration (i.e., time t₀) produces four filtered samples 410, the second iteration (i.e., time t₂) produces another four filtered samples 410, and so on. Thus, the processing speed of the speech signals is increased by approximately four times, as compared to the conventional method of AR model-based processing in series shown in FIG. 4. For example, in order to produce eight filtered samples 410, using the conventional AR method shown in FIG. 4, eight time-iterations are needed, instead of two time-iterations using the parallel processing method shown in FIG. 5. It should be noted, of course, that the value of n is not limited to four, and the number of speech segments and the number of ADFKs for processing the speech segments can be set to any suitable value based on the particular environment or application.

First, acquired speech signals are decomposed into several smaller segments 320, as described above, e.g., by grouping a finite number of samples 330 in each segment 320. Then, as shown in FIG. 5, the processing at time t₀ (i.e., initial filtering stage) involves the processing, in parallel, of four speech segments 320 (i.e., a first set of speech segments), each containing four unfiltered samples 330, using four different ADFKs, respectively. Therefore, the processing at time t₀ results in four filtered samples (filtered sample 1, filtered sample 2, filtered sample 3, filtered sample 4). During the initial filtering stage only, because estimated AR coefficients from KF2 may not yet be available to KF1, the only available input may be the unfiltered speech samples, and the coefficients or other information may be assumed.

Then, during the subsequent (i.e., “standard”) filtering stages, another four speech segments 320 (i.e., a second set of speech segments), each containing four unfiltered samples 330, can be processed in parallel using the four different ADFKs. For instance, at time t₁, a second set of the n speech segments (segment 5, segment 6, segment 7, segment 8) can be processed in parallel using the n unique ADFKs, whereby segment 5 contains filtered samples 5-8, segment 6 contains filtered samples 6-9, and so forth. Therefore, the processing at time t₁ results in four new filtered samples (filtered sample 9, filtered sample 10, filtered sample 11, filtered sample 12). Of course, as the amount of filtered samples 410 increases, the effectiveness of the noise reduction increases, as the ADFKs are able to estimate the speech samples with increasing accuracy over time (i.e., the filtered samples 410 are close to the actual, noise-less samples).

It should be noted that the processing speed increases by a factor proportional to the number of parallel ADKFs. Thus, in the case of FIG. 5, if the collaborative, parallel processing method 500 processes x speech segments 320, x/4 iterations of speech segment processing are performed to estimate x filtered samples 410, which is four times faster than the conventional method 400 shown in FIG. 4.

Accordingly, techniques are described herein that can be used to improve audio quality in vehicular Bluetooth applications, as well as any applications with desired speech enhancements, such as speech recognition applications in vehicles, which contributes to safer driving. As described above, adaptive dual Kalman Filters, with lower orders, are designed to work in parallel and collaborate with each other in order to reduce noise of different characteristics more effectively than a single complex filter with high order. Thus, the algorithms are simple and do not require high computational complexity due to the simplicity of dual Kalman Filtering. Further, conventional Kalman Filtering applications based on AR modeling were computationally complex, with a processing speed that slowed to an unacceptable level for real-time applications. In the present disclosure, however, collaborative Kalman Filters are utilized that work in parallel to improve processing speed and operational efficiency, in comparison with Kalman Filtering approaches performed in series. Thus, the adaptive dual Kalman Filtering techniques are useful even in real-time applications.

While there have been shown and described illustrative embodiments that provide adaptive dual collaborative Kalman filtering for vehicular audio enhancement, it is to be understood that various other adaptations and modifications may be made within the spirit and scope of the embodiments herein. For instance, the techniques described herein can be integrated into noise cancellation algorithms in Bluetooth modules and hands-free application in vehicles. Also, the described techniques can be implemented in transmitters in vehicles to filter out noises that are generated in the cabins; in this way, corresponding receivers can receive enhanced audio quality. Therefore, the embodiments of the present disclosure may be modified in a suitable manner in accordance with the scope of the present claims.

The foregoing description has been directed to embodiments of the present disclosure. It will be apparent, however, that other variations and modifications may be made to the described embodiments, with the attainment of some or all of their advantages. Accordingly, this description is to be taken only by way of example and not to otherwise limit the scope of the embodiments herein. Therefore, it is the object of the appended claims to cover all such variations and modifications as come within the true spirit and scope of the embodiments herein.

1. A method comprising:
acquiring speech signals in a vehicle;
dividing the speech signals into speech segments in time domain including one or more speech samples;
processing a set of the speech segments using dual Kalman filters, wherein:
each dual Kalman filter includes a first Kalman filter and a second Kalman filter,
each speech segment in the set is processed using a different dual Kalman filter, and
each speech segment in the set is processed in parallel with one another; and
synthesizing the processed speech segments to construct noise-reduced speech signals.

2. The method of claim 1, further comprising:
receiving vehicle information provided by a controller area network (CAN) bus of the vehicle indicating one or more sources of noise potentially affecting a cabin of the vehicle;
estimating noise parameters based on the received vehicle information; and
tuning the dual Kalman filters according to the estimated noise parameters,
wherein the set of speech segments is processed using the tuned dual Kalman filters.

3. The method of claim 2, wherein the vehicle information provided by the CAN bus includes one or more of: an engine speed, a fan level, a wind amount, a weather indication, a window position, a sunroof position, a radio volume level, a turn indicator status, a presence of passing vehicles, and a road feature.

4. The method of claim 1, wherein the processing comprises:
determining n dual Kalman filters, each of the n dual Kalman filters being different from one another; and
processing a first set of n speech segments in parallel with one another using the n dual Kalman filters,
wherein each of the n speech segments in the first set is processed, respectively, using a corresponding dual Kalman filter of the n dual Kalman filters.

5. The method of claim 4, wherein the processing further comprises:
processing a second set of n speech segments in parallel with one another using the n dual Kalman filters, wherein
each of the n speech segments in the second set is processed, respectively, using a corresponding dual Kalman filter of the n dual Kalman filters.

6. The method of claim 1, wherein the processing comprises:
determining n dual Kalman filters, each of the n dual Kalman filters being different from one another; and
processing a plurality of sets of n speech segments using the n dual Kalman filters, wherein:
each set of n speech segments is processed in a sequential order,
each of the n speech segments in any given set is processed in parallel with one another,
each of the n speech segments in any given set is processed, respectively, using a corresponding dual Kalman filter of the n dual Kalman filters.

7. The method of claim 1, wherein the dividing comprises:
grouping one or more speech samples in each speech signal, resulting in the speech segments.

8. The method of claim 1, wherein the one or more speech samples are grouped according to time.

9. The method of claim 1, wherein the speech segments contain a reduced amount of noise after the processing of each speech segment using the dual Kalman filters.

10. The method of claim 1, wherein the processing comprises:
estimating a speech sample based on a first speech segment among the set of speech segments based on one or more estimated coefficients using the first Kalman filter; and
estimating the one or more coefficients based on the estimated speech sample using the second Kalman filter.

11. The method of claim 10, wherein the one or more estimated coefficients are estimated according to an autoregressive (AR) model.

12. The method of claim 1, wherein each speech segment is processed using a different combination of a first Kalman filter and a second Kalman filter.

13. The method of claim 1, wherein the processed speech segments are noise-reduced speech segments.

14. The method of claim 1, wherein the speech signals are divided into speech segments according to time.

15. The method of claim 1, wherein the synthesizing comprises:
reconstructing speech segments based on filtered speech samples resulting from the processing of the speech segments using the dual Kalman filters; and
synthesizing the reconstructed speech segments to construct the noise-reduced speech signals.

16. An apparatus comprising:
an audio acquisition device acquiring speech signals in a vehicle; and
a controller installed in the vehicle configured to:
divide the speech signals acquired by the audio acquisition device into speech segments in time domain including one or more speech samples;
process a set of the speech segments using dual Kalman filters, wherein:
each dual Kalman filter includes a first Kalman filter and a second Kalman filter,
each speech segment in the set is processed using a different dual Kalman filter, and
each speech segment in the set is processed in parallel with one another; and
synthesize the processed speech segments to construct noise-reduced speech signals.

17. The voice recognition apparatus of claim 16, wherein the controller is further configured to:
receive vehicle information provided by a controller area network (CAN) bus of the vehicle indicating one or more sources of noise potentially affecting a cabin of the vehicle;
estimate noise parameters based on the received vehicle information; and
tune the dual Kalman filters according to the estimated noise parameters,
wherein the set of speech segments is processed using the tuned dual Kalman filters.

18. A non-transitory computer readable medium containing program instructions for performing a method in a vehicle, the computer readable medium comprising:
program instructions that divide speech signals acquired by an audio acquisition device in the vehicle into speech segments in time domain including one or more speech samples;
program instructions that process a set of the speech segments using dual Kalman filters, wherein:
each dual Kalman filter includes a first Kalman filter and a second Kalman filter,
each speech segment in the set is processed using a different dual Kalman filter, and
each speech segment in the set is processed in parallel with one another; and
program instructions that synthesize the processed speech segments to construct noise-reduced speech signals.

19. The non-transitory computer readable medium of 18, further comprising:
program instructions that receive vehicle information provided by a controller area network (CAN) bus of the vehicle indicating one or more sources of noise potentially affecting a cabin of the vehicle;
program instructions that estimate noise parameters based on the received vehicle information; and
program instructions that tune the dual Kalman filters according to the estimated noise parameters,
wherein the set of speech segments is processed using the tuned dual Kalman filters.
